(19) United States
(12) Patent Application Publication
(10) Pub. No.: US 2008/0252257 A1
(43) Pub. Date: Oct. 16, 2008

(54) Multiplexer and Switch-Based Electrochemical Cell Monitor and Management System and Method

(75) Inventors: Daniel A. Sufrin-Disler, Monrovia, CA (US); Peter F. Nortman, Monrovia, CA (US); Greg Hanssen, Irvine, CA (US)

Correspondence Address: SELDON & SCILLIERI, 10940 WILSHIRE BLVD., 18TH FLOOR, LOS ANGELES, CA, 90024-3952, US

(73) Assignee: Energy Control Systems Engineering, Inc. d/b/a EnergyCS, Monrovia, CA (US)

(21) Appl. No.: 11/909,972

(22) PCT Filed: Apr. 5, 2006
(86) PCT No.: PCT/US06/12763

§ 371 Date: Sep. 27, 2007

Related U.S. Application Data
(60) Provisional application No. 60/668,478, filed on Apr. 5, 2005.

(51) Int. Cl. H02J 7/00

(52) U.S. Cl. 320/118; 320/116

(57) ABSTRACT

A system for monitoring a plurality of battery cells using the switch and multiplexing circuits with the plurality of monitored signal indicating the battery voltage levels for each cell by switching the measured voltage of each cell and using switching of the monitored cell voltage to selectively measure each selected signal (10).

### FIELD OF THE INVENTION

The invention relates to electrochemical cell monitoring and management.

### BACKGROUND OF THE INVENTION

The need for monitoring and managing electrochemical cells, such as those found in batteries, is well known in the art in connection with a large variety of applications. The need for accurate cost-effective systems has become even more acute with the growing desire for electric vehicles, battery electric hybrid vehicles and plug-in battery-electric hybrid vehicles, although it will be clear that this invention is not limited to such applications.

The monitoring and managing of electrochemical cells becomes quite complex when multiple cells are used in parallel and series combinations. The electrochemical cell is frequently assembled into series or parallel arrangements to provide increased power or energy to its application. Parallel and series cell arrangements multiply the available power, stored energy, and voltage and or current. In situations where there are a number of cells arranged in a series/parallel arrangement, the weakest cell may cause a failure of the entire system. Monitoring of each cell group may be necessary to maintain working knowledge of the health of the electrochemical cell system, its status, available energy and power. Monitoring of the electrochemical cell group may also be also necessary to keep warranty records.

Balancing of cells may be required in situations where cells are not to be overcharged, over-discharged, or allowed to operate outside certain voltage ranges. In such cases, the cells must be monitored and managed to bring all cells to an even state of charge (or equally safe operating point). Even if cells are brought to an even state of charge, the manufacturing and assembly tolerances or defects, current or thermal imbalances can cause cells to operate at different capacities, and all of this should preferably be managed.

Typically monitoring of cells will include the measuring of their voltages and temperatures and then, possibly, calculating other cell characteristics via system software.

Measurements are also typically done on a pack level. These measurements such as pack current or pack voltage can be useful for taking care of the full battery pack. It is also common to try to ensure that the battery pack is isolated from the chassis of a vehicle or from other points for safety and to detect certain types of failure.

Finally, in some applications, other system voltages are read, contactors or relays can be used to disconnect the cells from the system, measurements are displayed, fans and chargers are controlled and other things are done to protect the cells and monitor their health.

Switched capacitor voltage-monitoring systems are known in the art which typically involve at least one switching device (hereinafter, a “switch”) for every voltage point to be monitored. In a switched capacitor system, switches will connect a capacitor across a cell or group of cells. This charges the capacitor so that the capacitor voltage will be equal to the cell voltage. The switches are then disconnected so that the capacitor is isolated relative to the cells. A second set of switches then connects the capacitor to a device that can measure the voltage. This allows the measurement device to be isolated from the batteries it is monitoring. An advantage to such systems is that they drain very little current from the batteries to make each measurement and they have no parasitic load associated with the measuring circuit when the device is off. If several cells are hooked up together, however, there are several voltage points to be measured and the price of the switches can become quite high.

A related voltage-monitoring system retains the switches but eliminates the capacitor. Two switches connect a voltage to a common bus. The voltage is measured by a measurement device that is always connected to the bus. This voltage measurement device will be referenced to the cells that it is measuring when the switches are closed, and can be isolated from another system as needed.

With the above variations, pack voltages, isolation measurements or other measurements can be taken by connecting one or more cells to the measurement bus at the same time as using other circuitry.

### SUMMARY OF THE INVENTION

The invention herein provides a novel system and method employing multiplexers and switching devices that allow for dramatically reduced part count over prior art systems while maintaining similar levels of safety and performance. The invention lends itself to relatively easily implementation in hardware and permits relatively simpler microprocessors to be used.

Briefly, a system is disclosed herein for monitoring a plurality of electrochemical cells, and comprises switch means, multiplexer means for monitoring signals indicative of the cell voltage levels of a plurality of cells, selection means for coupling selected ones of the monitored signals to the switch means at respective times, means for momentarily operating the switch means during a portion of each of the respective times to apply the selected signal to a measuring circuit, whereby the switch means is used to a plurality of cells to the measurement circuit as different signals are selected by the multiplexer.

Typically, the output from the switch means is electrically coupled to a measurement bus that, in turn, directs the voltage-indicative signal from the switch to the measurement circuit. The measurement circuit can employ switched capacitors or a floating measurement system to monitor the cell voltages.

By proper selection of multiplexer inputs, the voltages-indicative signals from the cells can also be used for other purposes such as pack monitoring, and isolation monitoring.

As used in this specification:

“Electrochemical cell” or “cell” means an electrochemical cell composed of planar or non-planar electrodes made of electrically conductive materials (such as metals, carbon or other group IV elements and compounds, composites, or plastics) in contact with a solid, plastic or liquid electrolyte. Examples of electrochemical cells are batteries, fuel cells, electrolyzers, and the like. Electrochemical cells may have organic and inorganic components in their makeup. The cell may or may not be contained in a container. The container, if any, may be electrically conductive or non-conductive. The cell may be free standing.

“Multiplexer” means a device that can choose one or more of several input signal options, including “no input”, to be connected to its output. Those of ordinary skill in the art recognize that different inputs or input combinations can be selectively chosen as the output with such a device. The connection may be bi-directional, or it may have a representation of the input signal on the output point in a unidirectional manner. Thus, a multiplexer and a switch may each have a mode where no signals are carried through to the output; i.e., where all switches are OFF or all inputs are DESELECTED.

“Pack” means a collection of electrochemical cells connected in series, in parallel or in a combination of series and parallel. For the purposes of this invention, a single cell can also qualify as a pack.

“Switch” means any device that can connect two points together and subsequently disconnect those points from each other. Some examples of switches are: relays, solid state relays, contactors, toggle switches, FETs, transistors, optocouplers, optoislators. It should be noted that a device containing more than one switch may be schematically presented herein as two individual switches.

In accordance with another novel aspect advantage of the invention, the components thereof may be mounted on a printed circuit board (“PCB”) configured to monitor, for example, up to 24 cells. The PCB may be designed to be able to be cut into smaller pieces that can monitor less than 24 cells. The method for breaking apart the PCB is detailed as part of this invention.

In accordance with another novel aspect of the invention, a layer of software abstraction can be used that allows use of a smaller microprocessor than has heretofore been necessary.

In accordance with yet another novel aspect of the invention novel controls are utilized to selectively discharge the cells for proper balancing.

Those of ordinary skill in the art will recognize that each of these aspects can be practiced without the others, and that the use of a plurality of them is not necessary except in practicing the preferred embodiment of this invention.

Lastly, it will be recognized by those of ordinary skill in the art that, while the diagrams show a certain number of cells connected to a multiplexer for illustrative purposes by way of example, that number of cells is not fixed. Where more or fewer cells could safely be connected to a multiplexer they can be connected without departing from the scope of the invention. Similarly, the number of cells which are connected to an isolator is not limited to the number shown by way of example in the drawings, but only by the safe application limits of a particular device.

Further details of the invention will be apparent to those of ordinary skill in the art from reading a description of the preferred embodiment of the invention described below, of which the drawings form a part.

### DESCRIPTION OF THE DRAWING

In the drawing,

FIG. 1 is a schematic illustration of a preferred cell-monitoring circuit constructed in accordance with the invention;

FIG. 2 is a schematic illustration of the cell measurement circuit of FIG. 1 with additional circuitry to allow the discharging of individual cells for cell balancing;

FIG. 3 is a schematic illustration of the cell measurement circuit of FIG. 2 with additional circuitry for allowing the discharging of individual cells for cell balancing;

FIG. 4 is a block diagram schematic of a circuit that can be utilized in accordance with the invention to measure pack voltage.

FIG. 5 is a block diagram circuit for measuring battery pack voltage and isolation in accordance with the invention;

FIG. 6 is a block diagram circuit for measuring battery pack voltage and isolation in accordance with the invention;

FIG. 7 is a block diagram of an alternate circuit for measuring battery pack voltage and isolation in accordance with the invention; and

FIG. 8 is a flow diagram illustrating a memory mapping technique used in accordance with a preferred embodiment of the invention

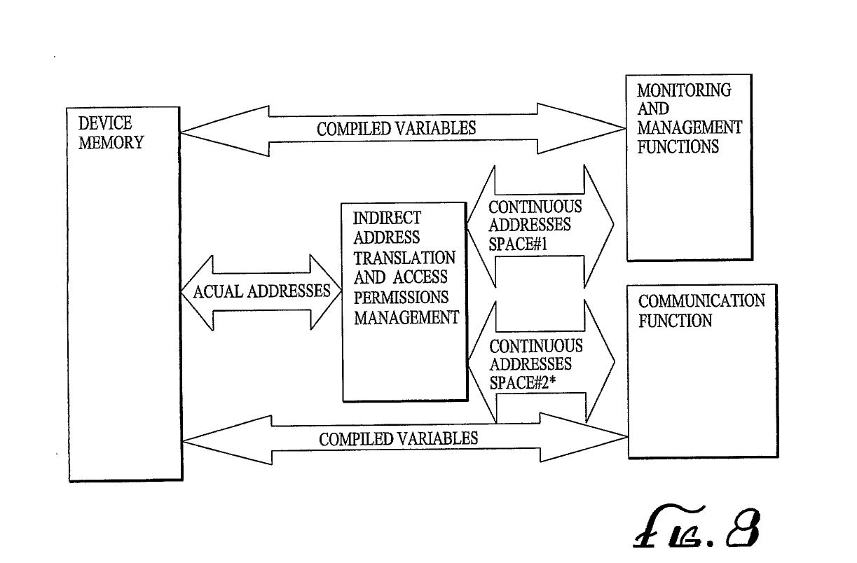

In the Figures, a schematically represented electrochemical cell can be a single cell, several electrochemical cells in parallel, one or more electrochemical cells in series (in which case not all voltage points in between the individual cells must be monitored), or a series/parallel combination.

In addition, it will be recognized by those of ordinary skill in the art that, for the sake of clarity, not all wiring will be shown. For example, switches will be shown with only two terminals, which are the points to be connected to each other or disconnected from each other. If the switch contains other points that could be connected to a point but are not used, they will not be shown. If control circuitry is needed to operate the switch, it may not be shown. For multiplexers, for example, the full circuitry needed for the select lines is not shown as the number of channels is not limited by the concept, but by the specific application and components being used. A person of ordinary skill in the art will, with the benefit of the description herein, be able to select components, complete the wiring and assign values to be able to accomplish the goals of this invention for various applications or for different applications.

In all of the diagrams, the main bus will be shown as two wires. Those of ordinary skill in the art will recognize that it is possible to have buses that are more or less than two wires and component blocks that end in more than two wires. It is also possible to have multiple buses connected to different blocks.

### DETAILED DESCRIPTION OF THE PREFERRED EMBODIMENT

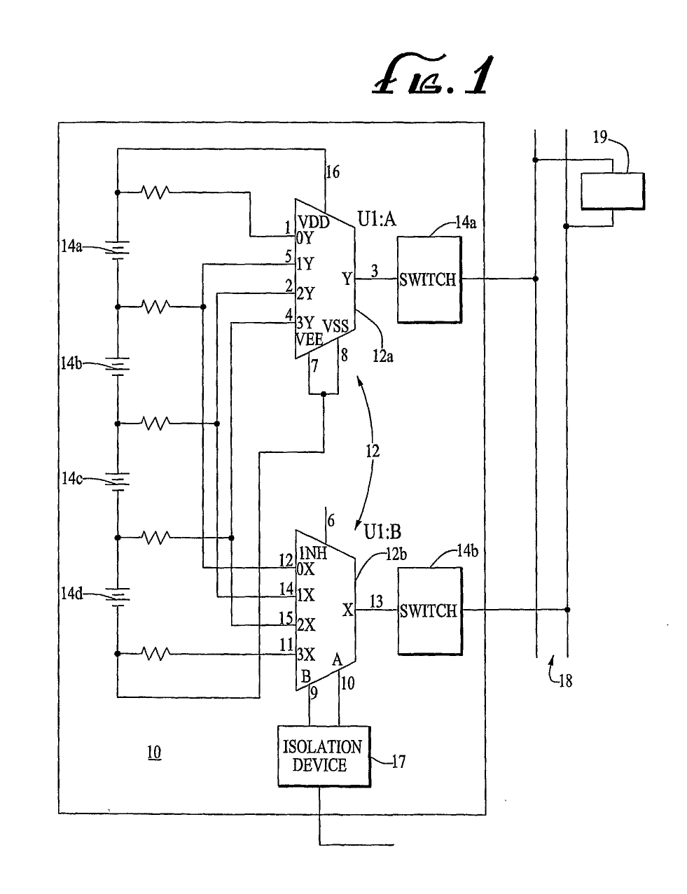

FIG. 1 is a schematic illustration of a preferred cell-monitoring circuit 10 constructed in accordance with the invention. A multiplexer 12 (illustrated as two blocks 12a, 12 b) is coupled at its input to a plurality of cells 14a-d. As shown, inputs “0Y” and “1Y” of the multiplexer are electrically coupled across cell 14a, inputs “1Y” and “2Y” and inputs “0X” and “1X” across cell 14b, inputs “2Y” and “3Y” and inputs “1X” and “2X” across cell 14c, and inputs “2X” and “3X” across cell 14c, inputs “0X” and 1X” across cell 14d. Each of the multiplexer inputs is coupled to its respective side of the respective cell through a current-limiting resistor. The outputs of multiplexers 12a, 12b are respectively coupled to a switch 14a, 14b. In this manner, a signal indicative of the voltage of any one of the cells can be selectively applied to the output of the multiplexer by selecting the inputs coupled to that cell.

In operation, a “select signal” generated by a control circuit is operable to cause the multiplexer 12 to repeatedly couple the voltage-indicative signal from each cell to the switch at its output. The switch is maintained in an “open condition” until the voltage indicative signal is applied to the switch's input, and the switch is then momentarily closed to apply that signal to a measuring bus 18, where it can be used to charge a capacitor (if a switching capacitor-type measuring circuit is used) or another type of measuring circuit 19 which may include an analog/digital converter to produce a microprocessor-compatible digital output value. Pack voltage can be measured by selecting inputs “0Y” and “3X”, or by selecting only input “0Y” in this module and comparing it with input “3X” of another module sharing the same common bus (where a second like module is attached to the pack in order to monitor additional cells thereof). The switches remain open until after the selected input is applied, and are opened before switching to the next cell, to provide isolation

Naturally, a chosen multiplexer may have a number of inputs sufficient to monitor more than the illustrated number of cells, and the invention is not limited to any particular number of cells per multiplexer or per module. If FIG. 1 represents a measurement module, the module can contain more than the illustrated number of multiplexers. It will be recognized by those of ordinary skill in the art that that a plurality of such modules can be cascaded as needed to monitor the number of cells used in any particular application, thus permitting the measurement circuit to remain unchanged

By placing a multiplexer between sets of electrochemical cells and switches in the foregoing configuration, the number of switches needed for a given set of voltage points is reduced. The leakage current for the multiplexer can be made to be incredibly low. The lower number of switches reduces the cost. Finally, the architecture of blocks hooked up to a common bus can be used to expand functionality inexpensively.

The illustrated multiplexer is isolated from other systems in its working environment by an isolator 17. As used herein, an “isolator” is a device that electrically isolates its input signals from its output signals. Sometimes, in the process of isolating the signals, its output will be different from the input. This can involve having open drain outputs, inverted outputs, buffered outputs or several other possibilities. Switches or relays that have electronic control signals which are not directly referenced to the electrochemical cells they are measuring may be considered isolated and could be considered isolators in this context. Some other examples of isolators are magnetic isolators and optical isolators.

Isolation measurements can be taken by means of the illustrated configuration by using a voltage taken from the output of the illustrated module and a voltage from a like module having the selected input connected to the chassis, or ground. Further, the illustrated module can be used to measure parameters other than cell voltage. Depending on the degree of isolation necessary, inexpensive isolation devices can be used to control the select lines for the multiplexer.

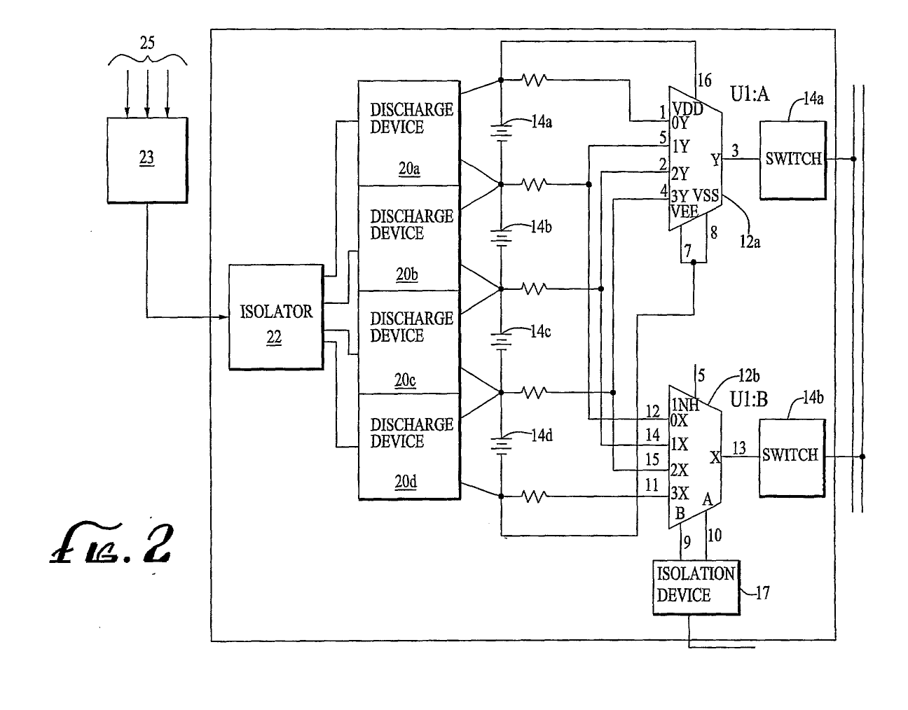

FIG. 2 shows the cell measurement block with additional circuitry to allow the discharging of individual cells. This allows cell balancing to be inexpensively added to a cell measurement block. Discharge devices 20a-d are respectively coupled across cells 14a-d and controlled by commands from a controller 23 coupled to the devices 20a-d through an isolation circuit 22. The discharge devices 20a-d may, for example, comprise a current-limiting resistor, a switch, an LED and resistor or a high resistance switch. Each discharge device is responsive to values 25 of such parameters as cell temperature and cell voltage to determine which cells need to be discharged to bring all cells into balance. Further, in hybrid vehicle applications for example, the controller can determine if the time is appropriate to balance the cells; for example, that there is no large current draw at the moment, or no high-rate charging of cells as by regen etc.

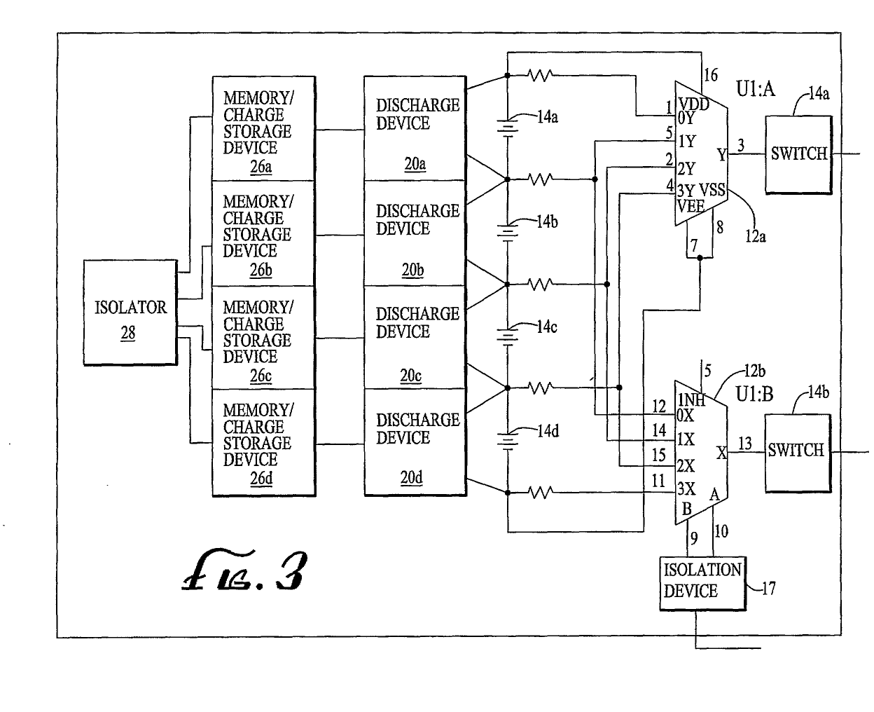

FIG. 3 is a schematic illustration of the cell measurement circuit of FIG. 2 with additional circuitry representing a further upgrade to the cell measurement block. This upgrade allows the balancing state to be stored so that other parts of the system can be shut down to conserve memory and power. Memory/charge storage devices 26a-d can hold the state of the balancing circuit “on” so that some or all of other systems can be powered down without affecting the balancing operation. One preferred memory/charge storage device is a MOSFET, wherein the gate is charged prior to such power-down. When its drain and source are subsequently de-energized, the gate stays “on”, maintaining the operation of cell balancing as charge is drawn off selected cells and discharged through an isolator 28. The storage is shown as being referenced to the cells, although those of ordinary skill in the art will recognize that the storage could also be placed on the other side of the isolator. It may be noted that one or more resistors, capacitors or other passive or active devices may be included between the memory storage devices and the isolator, depending on the type of discharge device to be used and consistent with good design practice resulting therefrom.

If the balancing is to be performed during idle periods for the cells, there are methods that can reduce the electrochemical cell monitoring current. In a system with pulse width modulation (“PWM”) duty cycles instead of individual timers, the PWM period is scaled so that the entire balancing cycle is one period. A timer controlling the PWM period and duty cycle wakes up the device at regular intervals to turn off balancing for groups of cells or to recharge the charge storage/memory devices. The advantage of the memory/charge storage method is that it requires very low supply power to supervise the balancing operation. With either the PWM or the individual timers, most of the functions of the electrochemical cell monitor can be put to sleep. It will then wake up to update the balancing of the cells as needed.

There are also enhancements that further reduce the device's standby power requirement. A method for performing balancing while the device is asleep was conceived; i.e., during periods when substantially all background power requirements are eliminated. The concept takes advantage of the high resistance between the gate and drain-source junctions of metal oxide field effect transistors and similar devices by loading the gate of the device with another device, and then driving the gate high with a tri-state device which can be ON/OFF/or high impedance.

Another method for reducing standby power requirements is to power the bypass off the cell it is discharging and have its state set using an external signal. When bypass is desired, the tri-state switch is loaded to the state desired (ON or OFF) and then the device is turned off. In similar fashion, the bypass state of a cell can be toggled ON and then external power is turned off. While the balancing is going on, the device draws no power from an external source. The device can wake up periodically and RESET the bypass state or load a new state, and then go back to sleep again.

Another method for reducing standby power requirements is hardware oriented. The hardware control lines for the balancing are setup with charge storage or memory devices on the inputs. In a timer-based system, the balancing would be enabled by turning on or charging up the memory storage devices. Once the individual timers expire, the memory devices would be turned off.

The basic invention is realized by connecting several blocks to a main bus. The blocks will be connected to the main bus one or more at a time.

Measurement of battery pack (hereinafter “pack”) voltage may require circuitry in addition to that shown in FIG. 1. For example, the module depicted in FIG. 1 may monitor 24 cells, while the pack consists of three such modules, or 72 cells. Accordingly, a pack voltage cannot be obtained from the output of a single module.

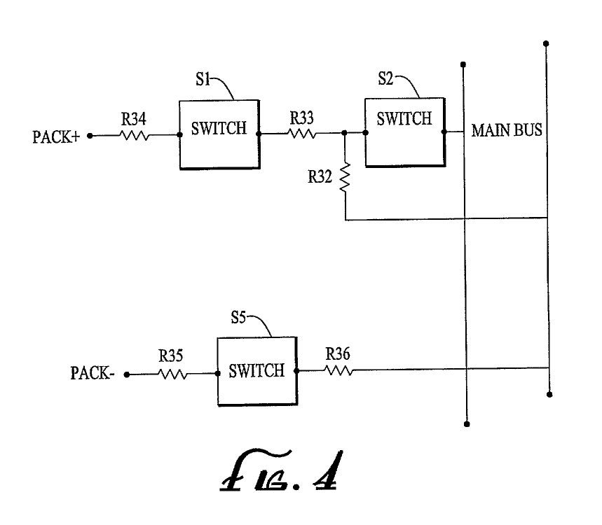

FIG. 4 is a block diagram schematic of a circuit that can be utilized in accordance with the invention to measure pack voltage. Briefly, the positive end of the pack and a negative end of the pack are electrically coupled to the main bus through a resistor divider to appropriately scale the voltage. Voltage scaling is likely necessary because the measurement circuit to utilize cannot measure voltages in the range of the actual pack voltage.

Referring to FIG. 4, the positive side of the pack is electrically coupled to the input of a switch S1 through a first resistor R34. The output of the second resistor R33 is electrically coupled through to the input of a second switch S2. The output of the second resistor R33 is also electrically coupled to the negative path of the main bus through a third resistor R32. The output of the second switch S2 is coupled to the positive path of the main bus. The negative side of the pack is coupled to the negative path of the main bus through a resistor R35, a third switch S5 and a second resistor R36.

In operation, the second switch S2 is first closed to connect positive and negative paths of the main bus through the resistor R32. Next, switches S1 and S5 are closed to place, with resistors R33 and R32 forming a voltage divider network, a pre-defined proportion of the pack voltage on the main bus. The voltage is then measured (either by charging a capacitor for subsequent measurement or through use of a measuring circuit). Switch S2 is then opened to prevent a discharge through resistor R32, and switches S1 and S5 are opened. At this point, the charged capacitor can be measured, if one has been used.

Instead of using the switch S5, the negative side of the pack could be selected through the cell measurement module that contains the cell. It is also possible to switch the positive side of the pack with the negative side of the pack in FIG. 4. All of these modifications are within the scope of this invention, as each would be apparent to one of ordinary skill in the art having the benefit of this disclosure.

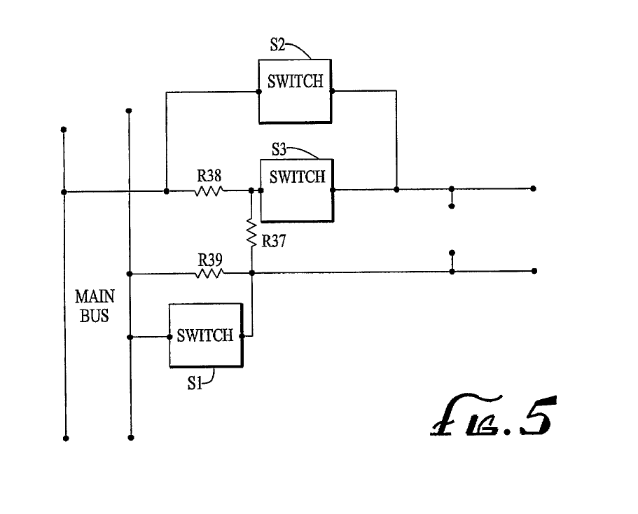

If the measurement device or the capacitor portion of the switched capacitor can deal with the pack voltage, the pack voltage can be connected to the main bus through the multiplexer blocks. One way of accomplishing this is by putting scaling in between the main bus and the switched cap or floating measurement circuitry. Moving the switches around slightly allows any of the voltages to be connected through the resistor divider. This method only works if a single module is measuring all of the voltages in the pack. If a single module only monitors a subset of the voltages, the pack voltage will have to measured either by using the other method or by connecting one pack pole through the appropriate multiplexer and the other pack pole through its own switch. See FIG. 5.

As shown in FIG. 5, the main bus can be used to measure either high voltage signals (by connecting S3 and possibly S1), or low voltage signals (by connecting S1 and S2). To check pack voltage, the pack voltage is connected across the main bus, and the high voltage measurement link is used.

When a pack is supposed to be isolated, and an isolation fault exists, there is an isolation resistance and a relative location in the pack at which the fault can be characterized. In order to calculate the isolation resistance and fault location, two equations and therefore two measurements are necessary.

A typical isolation detection circuit will weakly connect the pack to chassis at one point and then measure the current. If the pack is isolated, the current will be 0, if there is a fault, the current will depend on the location and strength of the fault. The detection circuit will then weakly connect to another point and make another measurement. This will allow the location and strength of any fault to be calculated. The weak connection can be a single connection or a resistive connection to multiple points giving an equivalent thevenin voltage location and resistance.

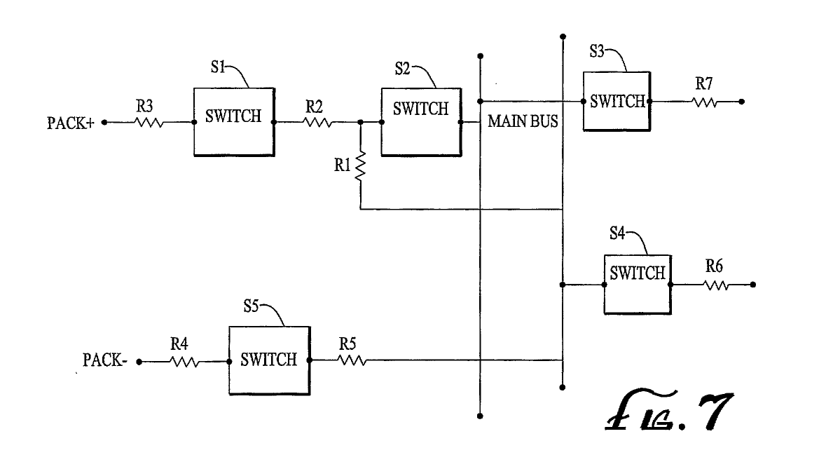

Referring to FIG. 7, switch S2 is closed, followed by switch S1 and then switch S4. The resulting voltage on the main bus is then used to charge a capacitor or measured, as previously described. Switch S2 is then disconnected, followed by switch S1 and switch S4. The voltage across the capacitor is measured, if there is one. This gives one data point. If resistor R6 is properly sized, the second point can be obtained by closing switch S2, then S4, then S1 and S5. The voltage measurement is taken, or capacitor charged as the case may be. Switch S2 is then disconnected, followed by the other switches. The voltage across the capacitor is measured, if there is one. A second way of obtaining the second point is to close S2, then S3 and S5. Measure the voltage or charge the capacitor, disconnect S2, then S3 and S5.

If the measurement circuitry is put in parallel with a tri-state buffer or equivalent, resistors R7 and R6 can be set to zero, and switches S3 and S4 can use the same switches that would connect the capacitor to the measurement circuitry. If using a floating measurement system, S4 can be used with a resistance and switch S3 may not be necessary.

This isolation technique can be combined with a multiplexer cell measurement and pack measurement wherever they can share circuitry. Where the switches in the cell measurement and pack measurement circuitry can serve the same functions as some of the switches in the isolation detection circuitry, the common components can be used for more than one purpose.

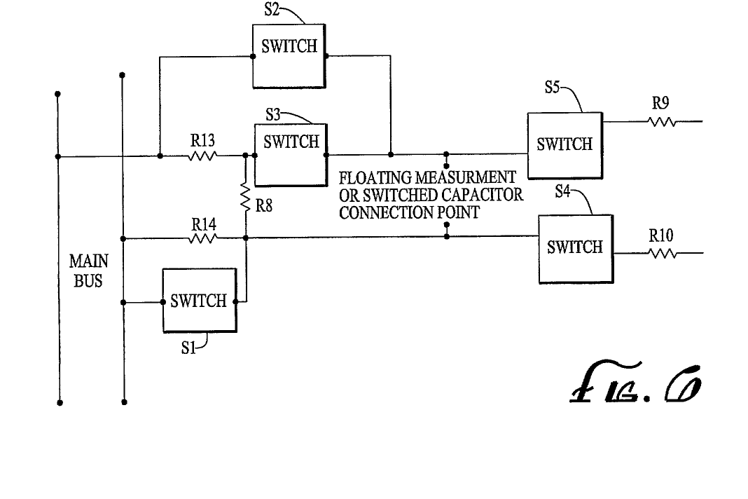

In FIG. 5, it illustrates the circuit for pack voltage measurements, the system can already select a high resistance path from different pack points to the common bus. By connecting a chassis or a reference voltage to the other side of the common bus, different points can easily be chosen. This is illustrated in FIG. 6.

If using the switched capacitor method, rather than the floating measurement configuration, the switches that connect the capacitor to the chassis-reference measurement can be used to complete the circuit to measure the isolation faults.

It is typically desirable to measure the current flowing from the battery pack. Those of ordinary skill in the art will understand that the same measurement device or capacitor bus can be connected through switches to a shunt to measure current. Other methods of measuring current involve Hall effect sensors or direct shunt measurements. These can be added to the device depending on the application.

The general software used herein is fairly straightforward. The switches and multiplexers select the voltage to be measured. The voltage is measured and then stored. The software at the same time uses the multiplexers to monitor one or more thermistors to measure cell temperature(s). This is also stored in memory. Pack voltage and isolation measurements can be made by accessing the correct multiplexers and switches. Current can be measured either separately from the voltages or during the same processes depending on the hardware configuration.

If energy consumption is critical, the software and hardware can operate in different power modes. The regular mode would take measurements as quickly as possible. A power saving mode can continue balancing while putting certain other sections of the board asleep.

The software can be programmed to have serial communication or take other actions based on the data. The software can also control the discharging devices to balance the cells as necessary.

The processor that was used was a smaller processor and some steps were needed to conserve the processors resources. Accordingly, some additional algorithms were used to make the program more efficient and flexible.

The software has a register that stores a running total of “current×time”, or fractions of “amp hours”. The time units are kept deliberately small to increase accuracy. The integration for the current is then as accurate as the current measurements. To keep the electrochemical cell monitoring software simple, the units for the current integration is not defined. Furthermore, responsibility for resetting it or translating it into a state of charge or discharge is transferred to another node capable of using the communication protocol. The second unit, knowing the current*time units and more details about the application, can keep track of SOC and Current throughput. It also has the ability to reset the value on the electrochemical cell monitor. This split responsibility for current integration ensures that the software for the electrochemical cell monitor does not have to be retested for most custom applications. It also insures that every likely battery can be accommodated by a single system.

Although the electrochemical cell monitor can be setup with high current balancing, electrochemical cells can also be kept in balance with smaller changes. In order to do this, the balance must be measured at either the end of charge, the end of discharge, or a custom point based on the application. Once a determination about the state of balance has been made, the balancing can be done while the cells are not in use, or during regular operation. Individual cells are balanced for varying amounts of time. These small changes in balance are sufficient to maintain a balanced set of cells. Once again, to keep the electrochemical cell monitors simpler, they provide rudimentary balancing algorithms and allow a custom communication node to best choose how to balance the batteries.

One of the methods in software that allows for the timer-based methods involves using individual timers for each cell. The cell timers decrement at regular intervals. The balancing is actively kept on for each cell until the specific timer hits zero. This allows an application to decide how much to balance each cell upon determination of the state of balance. The timers can also be commanded to large intervals on a regular basis to achieve an always on state and can be commanded to 0 for an always off state. By way of example, a discharge rate of 50 mA might be employed to balance the cells. If one cell is above the lowest cell by 100 mAh and a second cell is above the lowest by 50 mAh, one can approximate the need to discharge the first cell for two hours and the second cell for one hour. Thus, a timer can be employed to set the discharge of each cell for a specified amount of time and to only periodically check the cell to obtain an update on its condition. Thus, balancing may occur during periods of substantial power-down, during periods of cell use, or at any other desirable time with simple and cost-effective hardware and software.

Depending on the situation, the monitoring system can be programmed to turn on the balancing whenever the voltage exceeds a certain threshold. When it does, it will set the timers to a predetermined constant. In this way, a node that can communicate to this device and look at the timers, can see whenever the device is balancing. Furthermore, by knowing the initial value of the timer and noticing every time it increased, the node can determine how much energy was removed from each cell. This information can be used to determine the health of the cells, which cells required more balancing and the effectiveness of any other balancing algorithms.

To fit the algorithm into a small microcontroller with small banks of memory, a memory map was built, and is illustrated in FIG. 9. Instead of using arrays and pointers directly, an abstraction was used so that two consecutive elements of a structure would not need to occupy adjacent memory locations. To do this, all memory access was based on a contiguous address. Structures would be set up to occupy blocks of memory in this contiguous address. However, based on the map, the adjacent locations in the contiguous address could be mapped to different sections of actual memory to fit the same design into different microprocessor architectures. One of the advantages of this is that it allows arrays to be used that could not fit in regular memory. The contiguous address model also helps to keep communications organized. With any higher-level communications protocol that reads from and writes to addresses, the addresses can be set up along the contiguous map. Internal reads and writes are also set up along the same map. This simplifies memory based communications protocols in addition to making better use of the existing memory. Another benefit is that certain addresses in the contiguous model exist but need not be mapped to actual memory locations. This allows the device to be compatible with communications protocols that require an address space bigger than the microprocessor allows. See the attached diagram immediately below.

The Continuous address space #2 could be the same as #1. Furthermore, if more address spaces are needed, the address translation block could be set up with more than two address mappings.

One of the final aspects of the design that makes data collection more useful is the synchronize and pause function. Any communication node can use the communications system to broadcast a “synch and pause” message at an appropriate time. Upon receipt of the message, the devices will all start at the first electrochemical cell that they monitor. Once they have monitored all of the cells, they will stop recording the measurements so that the communications node can read a group of measurements all taken in the same, synchronized time frame.

To ensure that pack protection can be run in parallel with the “synch and pause” function, measurements are continuously made and important quantities such as maximum voltage are still computed. The only thing that changes is the recording of the individual cells into certain memory locations. This ensures that “pausing” the measurements does not adversely effect any other aspect of the electrochemical cell monitor. Synchronicity is important when making measurements because the values being compared are often changing with time.

Part of the design that allows for increased flexibility involves making a board that is expandable or contractable in contiguous “units” which repeat the same circuit. A single board “unit” is designed so that it can handle a single block of cells. Some of the communication lines can extend from one board to an identical board beside it. One board is completely populated with the microprocessor and the other boards become slave boards. Not knowing the application when the boards are built, it is easier to build several boards side by side. Once the application is known, some of the boards are split off from the rest and populated. There are two methods that enable the boards to be safely broken without having traces that could short to each other. In either method, the plane layers must not extend all the way to the edge of the possible break. This ensures that no signals can short to the planes.

The first method involves laying a resistor footprint across both boards. The communication line that has to bridge the boards is carried through a zero ohm resistor. If the resistor is not populated, the boards can be broken without any live signals having the ability to short.

The second method for having communication lines bridge boards involves setting up a via on either side of the bridge. If the boards are going to be cut, the trace is first cut in between the two vias. By spacing the traces sufficiently far apart, the traces are unable to short to each other. The via then functions to make sure that the trace cannot easily be pulled off of the board. The via should anchor it in place.

The current prototype of the invention uses up to 6 pcb boards connected end to end. The full combination can measure up to 24 voltages and 48 temperatures. It measures one current and has one external output (with more available) that can directly or indirectly control contactors or status LEDs.

In the current prototype, there are up to 6 cell blocks connected to 1 bus. This allows for up to 24 cell voltages to be monitored. There is a capacitor block with short circuits instead of switches connected to this bus. There is also a measurement block that can measure the voltages of the different devices. The main bus also has an area that could be populated with a pack voltage bus. First a cell block is connected to the bus which charges or discharges the capacitor. Then the cell block is disconnected and the measurement block is connected and a measurement is made.

In one embodiment of the invention, the device has an additional second bus for temperatures. The temperatures are measured using thermistors which are isolated from the cells. Because the thermistors are already isolated from the cells and pack, the switches used do not need to be able to deal with the entire pack voltage. The measurement device is permanently connected to the second bus as this does not cause any isolation issues. This can measure 48 temperatures.

The device has a third bus that measures a Hall effect sensor. The Hall effect sensor requires a 3 wire bus instead of two wires. This bus is permanently connected because the hall effect sensor can be isolated and there are no issues with the permanent connection.

The device uses PWM-based balancing in software with isolators driving gates to discharge the batteries for balancing. It is set up to discharge up to 50 mA per cell.

The device uses a microprocessor that has less than 400 bytes of RAM. To store all of the voltages and temperatures together requires a block of memory that cannot fit in adjacent memory locations in the microprocessor. The memory model maps everything so that all of the voltages and temperatures can be treated as if they fit together with a contiguous memory model. The device uses RS485/modbus communications to talk to any other devices. The modbus drivers use the same memory mapping as the rest of the application.

One embodiment of the invention contains cell voltage and temperature measurements, current measurement, balancing of cells, isolation detection, and data communication on one sub module; pack voltage and current measurements with an ambient temperature measurement with appropriate communications on a second sub module; and thermal system control, data communications to all other modules and submodules on a third sub module. Each module contains isolation circuitry as needed to protect the vehicle and keep the battery system and components healthy. Contactor control and external I/O is sensed and governed both directly and indirectly in the present embodiment, by sending information to the section of the vehicle that does contactor control using digital and hardware.

It uses all of the software algorithms that are used for this invention. The most recent software also calculates Cyclic Redundancy Checks on the stored calibration values, the stored constants for balancing and other systems and on the program code to protect systems against corruption.

A second version of this hardware was built in 3 different sizes and the functionality was split into two different PCBs. The first PCB came in an 8 cell, a 16 cell and a 24 cell version. Instead of using the switched capacitor configuration, this revision used the floating measurement configuration. The analog to digital convertor and the entire board reference floats relative to chassis. Communication is isolated through optoisolators and the power is provided through a DC-DC convertor. It has up to 2 temperature measurements per cell. Other than the floating capacitor measurement being switched to a floating measurement system, it has the same design as the revision 1 board.

The second PCB measures the pack voltage and the pack isolation using a common switched capacitor bus as in figure . . . . This PCB can also have some of the switches shorted to be configured as figure . . . . In addition to aspects of this invention, it measures pack current, does fan control, communicates with the first PCB, has a CAN communication port, and has contactor control capability.

Although the present invention and its advantages have been described in detail, it should be understood that various changes, substitutions and alterations can be made herein without departing from the spirit and scope of the invention as will be defined by appended claims.

We claim:

1. A system for monitoring a plurality of electrochemical cells comprising:
switch means having an input and output;
multiplexer means for monitoring signals indicative of the cell voltage levels of a plurality of cells, and having its output electrically coupled to the input of the switch means;
selection means electrically coupled to the multiplexer means for coupling selected ones of the monitored signals to the switch means at respective times via the multiplex means, and
means for momentarily operating the switch means during a portion of each of the respective times to apply the selected signal to a measuring circuit via the output of the switch means,
whereby the switch means is used to apply a plurality of cells to the measurement circuit as different signals are selected by the multiplexer.

2. The system of claim 1 wherein the multiplexer means and includes a plurality of input pairs, each pair being coupled across a respective cell.

3. The system of claim 1 wherein the coupling arrangement of the cells to the input pairs is such that the selection means is operable to select the monitored signals for individual cells of the plurality.

4. The system of claim 1 wherein the cells are electrically coupled together to form a pack, the coupling arrangement of the input pairs being such that the selection means is operable to select monitored signals from a pair of cells that is indicative of pack voltage.

5. The system of claim 1 including isolation measurement means comprising second multiplexer means having at least one input electrically coupled to “ground”, and for producing a second output signal when said “ground” input is selected,
said selection means including means for periodically selecting said “ground” input of said second multiplexer,
said switch means including means for periodically applying said second output signal to the measuring circuit for isolation measurement.

6. The system of claim 1 further including
controller means for monitoring at least one of each cell's temperature and voltage value, and
discharge means coupled across each of the cells and responsive to the controller means to discharge a cell when a monitored value of said cell is not in balance with the remaining cells.

7. The system of claim 6 wherein the discharge means includes a plurality of discharge devices coupled across a respective plurality of cells.

8. The system of claim 6 wherein the discharge means is responsive to the controller means only when the current drawn from the cell is less then a maximum permissible value.

9. The system of claim 6 wherein the discharge means is responsive to the controller means only when the cell discharge rate is less than a maximum permissible value.

10. The system of claim 6 further including memory means for allowing the balancing state of each cell to be stored to maintain operation of cell balancing when other parts of the system are shut down.

11. The system of claim 1 wherein said plurality of electrochemical cells are connected together to form a pack having positive and negative ends, and further including
a voltage divider circuit coupled to one of the positive and negative ends through said switch means for directing a scaled value of the monitored signal to the measurement circuit when the selected signal represents the pack voltage level.

12. The system of claim 1 wherein said plurality of electrochemical cells are connected together to form a pack having positive and negative ends, and further including
a voltage divider circuit coupled to one of the positive and negative ends through said switch means for directing a scaled value of the monitored signal to the measurement circuit when the selected signal represents the pack voltage level.

13. A method for monitoring a plurality of electrochemical cells comprising:
electrically coupling each of plurality of electrochemical cells to a respective multiplexer input;
coupling the output of the multiplexer to a switch that selectively couples and decouples the multiplexer output electrically to a measurement bus,
generating selection signals to the multiplexer to sequentially couple selected cells to the multiplexer output at respective time intervals
momentarily closing the switch during at least a portion of each respective time interval to electrically couple the multiplexer output to a measuring circuit,
whereby the switch applies signals for the cell plurality to the measurement circuit as different cells are selected for output by the multiplexer.

14. The method of claim 13 wherein each cell of the plurality is electrically coupled across a respective pair of multiplexer inputs so that a signal indicative of the voltage of the cell is applied to the switch when that multiplexer input pair is selected.

15. The method of claim 13 wherein the cells are electrically coupled together to form a pack, and including the step of electrically coupling the cells to the multiplexer inputs in an arrangement that permits the selection of signals indicative of pack voltage.

16. The method of claim 14 including the steps of
coupling a multiplexer input to electrical “ground”,
selecting said multiplexer input for electrical coupling of the resulting multiplexer output to the measurement circuit, and
selecting one multiplexer input of a cell-coupled pair for electrical coupling to the measurement circuit for isolation measurement with respect to the electrically coupled “ground” output from the multiplexer.

17. The method of claim 13 including the additional steps of
monitoring at least one of each cell's temperature and voltage value, and
discharging a cell when its monitored value is not in balance with the remaining cells to thereby bring said cell into balance.

18. The method of claim 17 including the step of electrically coupling a plurality of discharge devices coupled across a respective plurality of cells.
